(19) United States
(12) Patent Application Publication
(10) Pub. No.: US 2009/0206216 A1
(43) Pub. Date: Aug. 20, 2009

(54) Suction Device and Suction Method Using Suction Device

(76) Inventor: Yoshio Katsutani, Tokyo (JP)

Correspondence Address: BIRCH STEWART KOLASCH & BIRCH, PO BOX 747, FALLS CHURCH, VA, 22040-0747, US

(21) Appl. No.: 12/225,377

(22) PCT Filed: Mar. 12, 2007
(86) PCT No.: PCT/JP2007/054774

§ 371 Date: Sep. 19, 2008

(30) Foreign Application Priority Data
Mar. 20, 2006 (JP) 2006-077408

(51) Int. Cl. F16B 47/00

(52) U.S. Cl. 248/205.8

(57) ABSTRACT

To prevent a surface of a workpiece from being scratched and allow the workpiece to be reliably held even in sucking and holding a workpiece having a curved portion or an inclined portion. A support member 4 is provided on a lower portion of a cylindrical portion 2 provided with a piston member 6 therein, a small diameter hole 10 and a large diameter hole 11 through which a piston rod 8 is passed are formed in the support member 4, and a vacuum cup 16 is mounted to a tip of the piston rod 8. A first suction hole 13 is provided from a side surface of the support member 4 to the large diameter hole 11, a third suction hole 17 opening into the vacuum cup 16 is provided at the center of the piston rod 8, and a second suction hole 18 that provides communication between the large diameter hole 11 and the third suction hole 17 is provided. A communication area of the second suction hole 18 communicating with the third suction hole 17 is smaller than a communication area of the large diameter hole 11 communicating with the piston chamber 5.

### TECHNICAL FIELD

The present invention relates to a suction technique suitable for a device for transferring, for example, curved resin molded articles such as bumpers that are automobile components.

### BACKGROUND ART

Conventionally, when curved resin molded articles such as bumpers that are automobile components are transferred by a transfer device, workpieces have been held by a suction device and transferred. For accommodating workpieces having different shapes with one device in such a case, a technique of using a variable shape attachment that can secure a suction rod to which a suction pad is mounted at any position by a lock cylinder, and change a direction of the suction pad (for example, see Patent Document 1), and a technique of allowing an angle of a suction pad to be freely changed by a rotary joint without deforming a workpiece having a varying thickness (see Patent Document 2) have been known.

Patent Document 1: Japanese Patent Laid-open No. 11-180552

Patent Document 2: Japanese Patent Laid-open No. 5-92385, FIG. 3

In either of the above described techniques, a direction of a suction surface of the suction pad can be changed to ensure a final holding function. However, when the suction pad abuts against a curved portion or an inclined portion of a workpiece, suction is performed while the suction pad slides diagonally along a workpiece surface until the suction pad opposes the suction surface after the abutment, which may cause a surface of a resin molded article to be scratched.

Therefore, the present invention has an object to prevent a surface of a workpiece from being scratched and allow the workpiece to be reliably held even in sucking and holding a curved portion or an inclined portion of the workpiece.

### DISCLOSURE OF THE INVENTION

To achieve the above described object, the present invention provides a suction device wherein a support member is liquid-tightly provided on a lower portion of a cylindrical portion provided with a piston member therein and having a piston chamber, a small diameter hole through which a piston rod extending from the piston member is passed, and a large diameter hole having a larger diameter than the small diameter hole and communicating with the piston chamber are coaxially formed at the center of the support member, a suction member is provided at a tip of the piston rod, an elastic member is provided between the piston member and the support member, the support member has a first suction hole opening into the large diameter hole from a side surface thereof, the piston rod has a bag-hole shaped third suction hole formed along a central axis and opening into the suction member, and a second suction hole that always provides communication between the large diameter hole and the third suction hole, and a communication area of the second suction hole communicating with the third suction hole is smaller than a communication area of the large diameter hole communicating with the piston chamber.

The communication area of the large diameter hole communicating with the piston chamber refers to an area of a planar region of a communicating portion between the piston chamber and the large diameter hole, and the communication area of the second suction hole communicating with the third suction hole refers to a sectional area of the second suction hole.

Also, as set forth in claim 2, the suction device is placed near a workpiece, and then vacuum suction is performed through the first suction hole to advance the suction member, which has a low suction force, and after the suction member abuts against the workpiece, the suction force is increased to suck and hold the workpiece.

Specifically, the vacuum suction is performed through the first suction hole, and thus air in the piston chamber and the third suction hole are simultaneously sucked through the large diameter hole. However, since the communication area of the second suction hole communicating with the third suction hole is smaller than the communication area of the large diameter hole communicating with the piston chamber, suction in the piston chamber is performed with higher priority to allow the suction member at the tip of the piston rod to be advanced toward the workpiece. The suction force of the suction member is still low at the time when the suction member abuts against the workpiece, and then the suction force is increased, thereby preventing a surface of the workpiece from being scratched.

In this case, a suction surface of the suction member is preferably previously adapted to a surface shape of the workpiece and set so as to substantially vertically abut against the surface of the workpiece.

The vacuum suction is performed through the first suction hole, and thus the advance of the suction member and the suction in the suction member can be simultaneously performed. In this case, the suction force is adapted to be low at the time when the suction member abuts against the workpiece and then be increased, thereby preventing the surface of the workpiece from being scratched.

### BRIEF DESCRIPTION OF THE DRAWINGS

FIG. 1 is a front view of a transfer device to which a suction device according to the present invention is applied;

FIG. 2 is a side view thereof;

FIG. 3 is a partial sectional view of an internal structure of the suction device; and

FIG. 4 illustrates a suction state.

### BEST MODE FOR CARRYING OUT THE INVENTION

An embodiment of the present invention will be described with reference to the accompanying drawings.

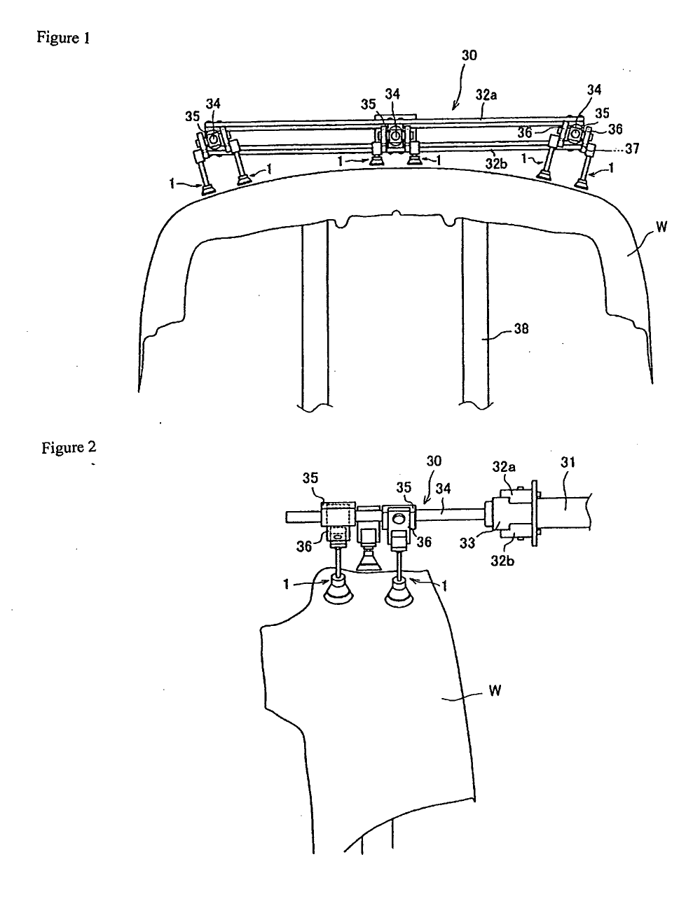

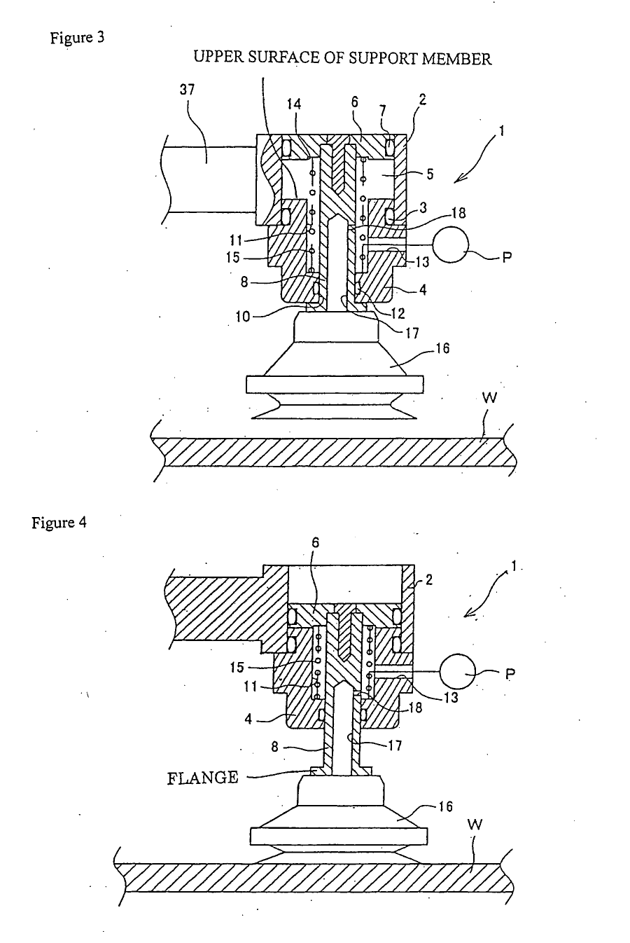

FIG. 1 is a front view of a transfer device to which a suction device according to the present invention is applied, FIG. 2 is a side view thereof, FIG. 3 is a partial sectional view of an internal structure of the suction device, and FIG. 4 illustrates a suction state.

The suction device according to the present invention is adapted to prevent a surface of a workpiece from being scratched and allow the workpiece to be reliably held even in sucking and holding a curved portion or an inclined portion of the workpiece. In this embodiment, the suction device is applied to a device for transferring a resin bumper W that is an automobile component.

Specifically, as shown in FIGS. 1 and 2, a transfer device 30 of the bumper W is provided at a tip of a robot arm 31, and includes two upper and lower holding plates 32a and 32b extending at a tip of the arm 31 perpendicularly to an extending direction of the arm 31, base plates 33 fastened between the holding plates 32a and 32b at three points of the center and the opposite ends, a support rod 34 protruding forward from each base plate 33, two front and back movable blocks 35 threaded on each support rod 34, a support plate 36 provided on one side of each movable block 35, and a suction device 1 mounted to the support plate 36 by a fastening member 37.

The suction device 1 provided on the support rod 34 at the center is positioned so that a suction surface is substantially horizontal for sucking a substantially planer surface portion of the bumper W, and the suction devices 1 provided on the support rods 34 at the opposite ends are positioned so that suction surfaces are tilted inward for sucking curved surface portions of the bumper W, and thus all the suction surfaces can oppose the surface of the workpiece.

As shown in FIG. 3, the suction device 1 includes a cylindrical portion 2 formed at a tip of the fastening member 37, and a support member 4 liquid-tightly threaded on a lower portion of the cylindrical portion 2 via a packing 3. In the cylindrical portion 2, a piston member 6 is slidably provided in a piston chamber 5 via a packing 7. In the support member 4, a small diameter hole 10 through which a piston rod 8 extending from the piston member 6 can be passed, and a large diameter hole 11 having a larger diameter than the small diameter hole 10 are coaxially formed, and a packing 12 is provided between the small diameter hole 10 and the piston rod 8.

The large diameter hole 11 and the piston chamber 5 communicate with each other, and a first suction hole 13 is provided from a side surface of the support member 4 to the large diameter hole 11.

In a chamber side of the piston member 6, a circular notch recess 14 is formed on the outside of the piston rod 8, and a spring 15 as an elastic member is provided between the notch recess 14 and a bottom of the large diameter hole 11 in the support member 4 to press the piston member 6 upward.

A vacuum cup 16 as a suction member is mounted to a tip of the piston rod 8, and a third suction hole 17 opening into an end surface of the vacuum cup 16 is formed into a bag-hole shape at the center of the piston rod 8. A second suction hole 18 having a small diameter is provided in a wall surface of the piston rod 8 so as to always maintain communication between the third suction hole 17 and the large diameter hole 11. Specifically, as shown in FIG. 4, the second suction hole 18 is formed in such a position that maintains communication between the third suction hole 17 and the large diameter hole 11 even when the piston member 6 is lowered to a maximum stroke.

A sectional area of the second suction hole 18 is extremely smaller than a communication area of a communicating portion between the large diameter hole 11 and the piston chamber 5.

In the suction device 1 as described above, a vacuum pump P is connected to the first suction hole 13 to perform vacuum suction through the first suction hole 13.

Next, operations of the suction device 1 will be described.

The transfer device 30 at the tip of the robot arm 31 moves to a suction position immediately above the bumper W placed on a frame 38 (FIG. 1) and stops. A positional relationship between the suction device 1 and the bumper W at this time is as shown in FIG. 3, and the piston member 6 is raised by the action of the spring 15.

In this state, the vacuum suction is performed by the vacuum pump P. Then, the communication area of the second suction hole 18 is smaller than the communication area between the large diameter hole 11 and the piston chamber 5, and thus vacuum suction in the piston chamber 5 is performed with higher priority than vacuum suction in the vacuum cup 16. Thus, the piston member 6 is lowered in the cylindrical portion 2, and thus the piston rod 8 and the vacuum cup 16 are lowered. At this time, suction is performed by an extremely low suction force in the vacuum cup 16.

When the vacuum cup 16 is lowered to abut against the surface of the bumper W and then further slightly lowered, the vacuum cup 16 contracts, and as shown in FIG. 4, the piston member 6 abuts against an upper surface of the support member 4 and stops. Then, suction thereafter is entirely performed through the second suction hole 18, and the suction force of the vacuum cup 16 is increased to firmly hold the bumper W.

Then, in a final suction state, the transfer device 30 is moved to a different transfer place by the robot arm 31 for transfer. In sucking and holding the bumper W, the suction force is low at the time when the vacuum cup 16 abuts against the bumper W, and then the suction force is increased, thereby preventing the surface of the bumper W from being scratched.

The present invention is not limited to the above described embodiment. Any modifications having substantially the same configuration as that described in claims of the present invention and having the same operation and effect belong to the technical scope of the present invention.

For example, any kind of workpiece may be treated.

### INDUSTRIAL APPLICABILITY

A suction force is low at the time when a suction member abuts against a workpiece surface, and then the suction force is increased to suck and hold a workpiece. Thus, sucking and holding a workpiece having a curved or inclined surface does not cause the workpiece surface to be scratched, and the present invention is highly practical in a transfer device of a workpiece that places importance on surface quality.

1-2. (canceled)

3. A suction device comprising:
a support member being liquid-tightly provided on a lower portion of a cylindrical portion provided with a piston member therein and having a piston chamber, a top surface of the support member being formed as a lower end stopper to restrict the lowering movement of the piston member;
in the center of the support member, a small diameter hole being provided through which a piston rod extending from said piston member is passed, and a large diameter hole being provided with a larger diameter than the small diameter hole and communicating with said piston chamber, the both holes being coaxially formed;
a suction member being provided at a flange formed at a tip of said piston rod, the flange being formed as a stopper to restrict the ascending movement of the piston member;
an elastic member being provided between said piston member and said support member;
a first suction hole being provided in the support member and opening into said large diameter hole from a side surface of the support member;
in the piston rod, a bag-hole shaped third suction hole being formed along a central axis and opening into said suction member, and a second suction hole being provided in a side surface of the piston rod, the second suction hole providing communication between said large diameter hole and said third suction hole all the time while the piston member being moving between upper and lower ends therefor;
wherein a communication area of the second suction hole communicating with said third suction hole is smaller than a communication area of the large diameter hole communicating with said piston chamber.

4. A suction method using a suction device according to claim 3, wherein said suction device is placed near a workpiece, and then vacuum suction is performed through said first suction hole to advance the suction member, which has a low suction force, and after the suction member abuts against the workpiece, the suction force is increased to suck and hold the workpiece.
